(19) United States
(12) Patent Application Publication
(10) Pub. No.: US 2010/0142562 A1
(43) Pub. Date: Jun. 10, 2010

(54) INTERFACE APPARATUS AND RESYNCHRONIZATION METHOD

(75) Inventor: Makoto ITO, Kasugai (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONIC LIMITED, Tokyo (JP)

(21) Appl. No.: 12/625,041

(22) Filed: Nov. 24, 2009

(30) Foreign Application Priority Data
Dec. 10, 2008 (JP) 2008-314489

(51) Int. Cl. H04J 3/06; H04B 1/38; G06F 13/42

(52) U.S. Cl. 370/503; 375/220; 710/106

(57) ABSTRACT

An interface apparatus that transmits and receives data to and from another node coupled via a bus cable includes a port coupled to a port of the another node through the bus cable, a connection management state machine which corresponds to the port and changes the port from an active state to an inactive state when a synchronism of the port is lost, a state transition suppression circuit which generates a state transition suppression signal to suppress the change of the port from the active state to the inactive state, and a synchronization state machine that starts a resynchronization of the port in the active state based on the detection of the synchronism of the port being lost.

### CROSS-REFERENCE TO RELATED APPLICATIONS

This application claims the benefit of priority from Japanese Patent Application No. 2008-314489 filed on Dec. 10, 2008, the entire contents of which are incorporated herein by reference.

### BACKGROUND

1. Field

The embodiments discussed herein relate to an interface apparatus and resynchronization method.

2. Description of the Related Art

The IEEE 1394b standard defines one of the serial interfaces for interconnecting the nodes of a personal computer, a digital camera and a color page printer handling a great amount of audio and video data.

The related technique is described in Japanese Laid-open Patent Publication No. 2004-72770.

### SUMMARY

According to one aspect of the embodiments, an interface apparatus that transmits and receives data to and from another node coupled via a bus cable. The interface apparatus includes a port coupled to a port of the another node through the bus cable, a connection management state machine which corresponds to the port and changes the port from an active state to an inactive state when a synchronism of the port is lost, a state transition suppression circuit which generates a state transition suppression signal to suppress the change of the port from the active state to the inactive state, and a synchronization state machine that starts a resynchronization of the port in the active state based on the detection of the synchronism of the port being lost.

Additional advantages and novel features of the various embodiments will be set forth in part in the description that follows, and in part will become more apparent to those skilled in the art upon examination of the following or upon learning by practice of the various embodiments.

### BRIEF DESCRIPTION OF THE DRAWINGS

FIG. 1 illustrates an exemplary synchronization method;

FIG. 2 illustrates an exemplary network system;

FIG. 3 illustrates an exemplary interface circuit;

FIG. 4 illustrates an exemplary state transition of a connection management state machine;

FIG. 5 illustrates an exemplary physical layer processing circuit;

FIGS. 6A and 6B illustrate an exemplary state transition of a synchronization state machine;

FIGS. 7A through 7E illustrate an exemplary resynchronization method;

FIG. 8 illustrates an exemplary a resynchronization method;

FIG. 9 illustrates an exemplary a physical layer processing circuit;

FIG. 10 illustrates an exemplary a resynchronization method;

FIGS. 11A and 11B illustrate an exemplary network system;

FIG. 12 illustrates an exemplary resynchronization method;

FIGS. 13A and 13B illustrate an exemplary state transition of a synchronization state machine.

### DESCRIPTION OF EMBODIMENTS

In the data transfer method according to the IEEE 1394b standard, for example, an 8-bit data to be transmitted is scrambled at the port of the node at the transmitting end (hereinafter referred to as the transmitting-end node). The 8-bit data thus scrambled is converted to a 10-bit code. The 10-bit data thus converted is transmitted to the port of the node at the receiving end (hereinafter referred to as the receiving-end node) from the port of the transmitting-end node. In the port of the receiving-end node, the 10-bit data received is converted to an 8-bit code and descrambled. At the receiving-end node, whether the 10-bit data received exists in the 10-bit/8-bit code conversion table or not is judged and whether the data is transmitted and received normally to and from the transmitting-end node is confirmed. If an instantaneous noise occurs by static electricity or the like in the bus cable coupling the ports of the transmitting-end node and the receiving-end node, for example, an abnormal 10-bit data not existing in the 10-bit/8-bit code conversion table may be received by the receiving-end node. Upon successive reception of abnormal 10-bit data a given number of times, the receiving-end node determines that the data is not transmitted and received normally to and from the transmitting-end node and thereby judges that the ports of the transmitting-end node and the receiving-end node are out of synchronism, i.e. have lost the synchronism (sync-lost state). In such a case, the bus cable coupling the ports of the two nodes may be logically cut off and the data transfer between the nodes may be suspended. In the data transfer method according to IEEE 1394b standard, the data transfer, if suspended by an instantaneous noise, is restored automatically to the state in which the data is transferred.

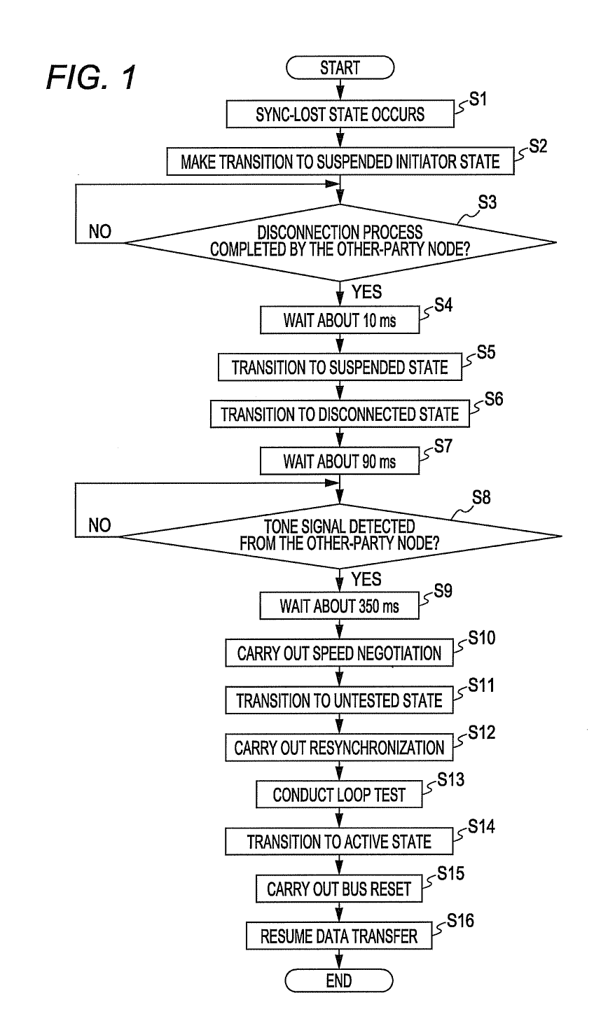

FIG. 1 illustrates an exemplary synchronization method. When the synchronism is lost while the port of each node is in an active state, for example, an activated state (operation S1), for example, each port makes transition to a suspended initiator state such as a deactivated state (operation S2). Upon completion of the disconnection process by the other-party node (YES in operation S3), each port stands by (waits) for about 10 ms (operation S4) and then automatically makes transition to the suspended state (operation S5). Further, each port makes transition to the disconnected state (operation S6). After that, each port stands by for about 90 ms (operation S7). Upon detection of the tone signal from the other-party node (YES in operation S8), each port further stands by for about 350 ms (operation S9). After that, the speed negotiation is carried out (operation S10). Upon normal completion of the speed negotiation, each port makes transition to the untested state (operation S11) and the synchronization between the ports is carried out (operation S12). Upon completion of the synchronization between the ports, the loop test is conducted (operation S13). Unless a loop is detected in a topology, each port makes transition to the active state (operation S14). Then, the bus is reset (operation S15), and the data may be transferred.

It may take about 600 to 700 ms before completion of a series of operations S1 to S16. When only an instantaneous noise occurs in the bus cable without any physical disconnection, the data transfer may be suspended.

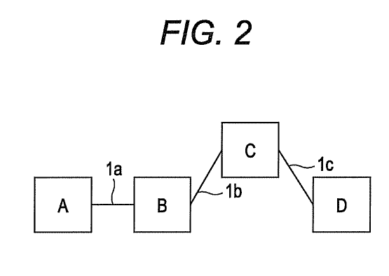

FIG. 2 illustrates an exemplary a network system. The network system (topology) illustrated in FIG. 2 may be based on IEEE 1394b standard. A node A is coupled to a node B through an IEEE 1394b bus cable (bus cable) 1a. The node B is coupled to a node C through a bus cable 1b. The node C is coupled to a node D through a bus cable 1c. The nodes A to D include the connection points of, for example, the personal computer, the printer, the digital camera, and the digital VTR.

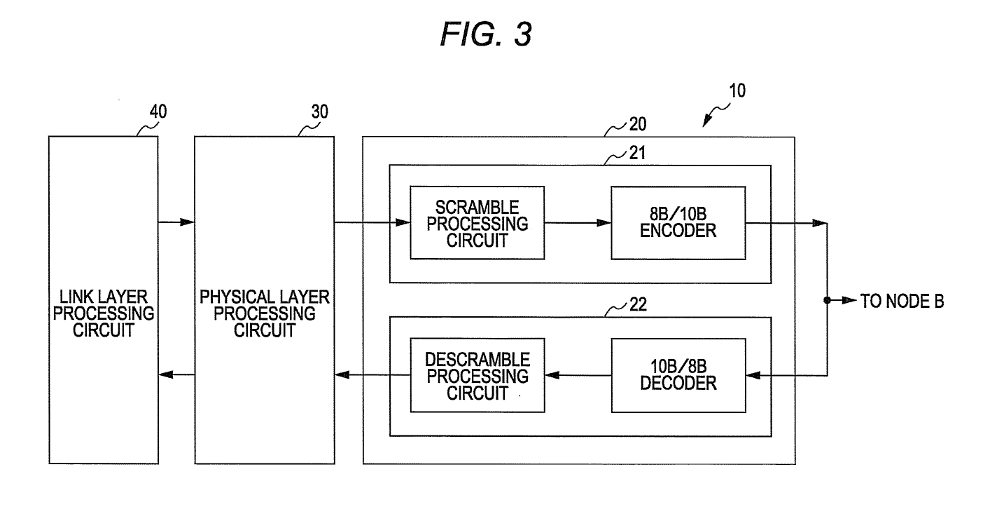

FIG. 3 illustrates an exemplary interface circuit. The nodes A to D may include the interface circuit 10, for example, illustrated in FIG. 3. The interface circuit 10 illustrated in FIG. 3 includes an IEEE 1394b port (port) 20, a physical layer processing circuit 30 and a link layer processing circuit 40. The port 20 includes a transmission circuit 21 and a reception circuit 22. The transmission circuit 21 is coupled to the reception circuit 22 of the node B through the bus cable 1a. The transmission circuit 21 converts an electrical signal such as the transmission data from the physical layer processing circuit 30 into an electrical signal conforming with IEEE 1394b standard and transmits the converted electrical signal to the reception circuit 22 of the other-party node (the other node) B. Transmission circuit 21 scrambles the electrical signal such as an 8-bit data from the physical layer processing circuit 30 and converts the scrambled electrical signal to a 10-bit code. The converted 10-bit data is transmitted to the other-party node B.

The reception circuit 22 of the node A is coupled to the transmission circuit 21 of the node B through the bus cable 1a. The reception circuit 22 converts the electrical signal such as the received data from the node B into an electrical signal handled in the apparatus and outputs to the physical layer processing circuit 30. The reception circuit 22 converts the received electrical signal such as the 10-bit data into an 8-bit code and descrambles the converted 8-bit data. The descrambled electrical signal is output to the physical layer processing circuit 30.

The interface circuit 10 illustrated in FIG. 3 includes a port 20, and the node may include 16 ports. The physical layer processing circuit 30 converts an electrical signal into a logic signal, converts a logic signal into an electrical signal, manages the port connection, and synchronizes and resynchronizes the ports.

The physical layer processing circuit 30 is coupled to the link layer processing circuit 40. The physical layer processing circuit 30 outputs the electrical signal such as packets input from the other-party node B through the reception circuit 22 of the local node A to the link layer processing circuit 40. The physical layer processing circuit 30 converts the electrical signal into a logic signal handled by the link layer processing circuit 40. The physical layer processing circuit 30 outputs the packets input from the link layer processing circuit 40 to the transmission circuit 21 of the port 20. The logic signal handled by the link layer processing circuit 40 is converted to an electrical signal by the physical layer processing circuit 30.

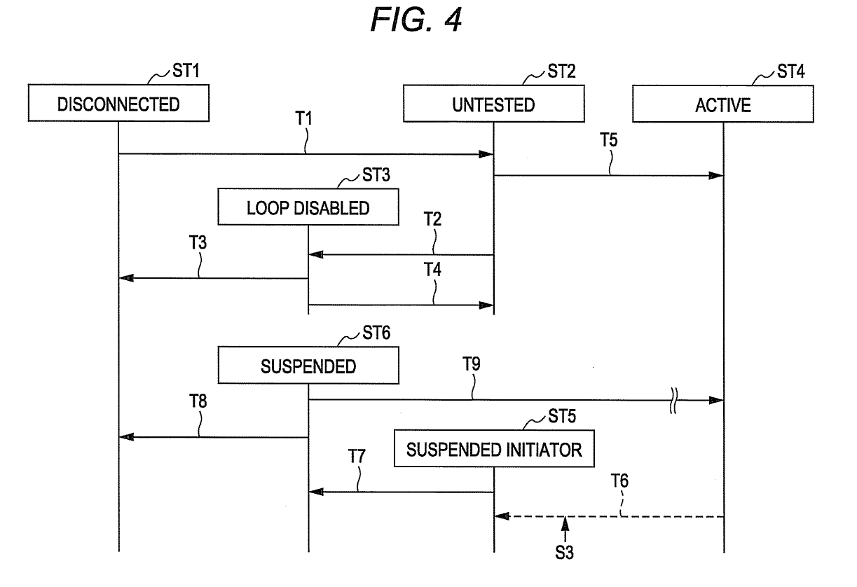

FIG. 4 illustrates an exemplary state transition of a state machine. The physical layer processing circuit 30 illustrated in FIG. 3 may include a connection management state machine 31 illustrated in FIG. 4. The connection management state machine 31 manages the connection state of the port 20 such as the disconnected state ST1, the untested state ST2, the loop disabled state ST3, the active state ST4, the suspended initiator state ST5 or the suspended state ST6.

The physical layer processing circuit 30 illustrated in FIG. 3 synchronizes the ports 20 of the nodes A and B based on the synchronization data such as the training code input from the other-party node B through the reception circuit 22 of the local node A. After complete synchronization, the physical layer processing circuit 30 continuously judges whether the synchronism between the ports 20 of the nodes A and B is lost or not, based on the electrical signal such as the 10-bit data input from the other-party node B through the reception circuit 22 of the local node A. When the physical layer processing circuit 30 detects that the synchronism is lost, for example, detects that the continuous abnormal 10-bit data due to a noise is received, the physical layer processing circuit 30 reduces the transition time of the ports 20 from the active state ST4 to the suspended initiator state ST5. For example, the transition time may be reduced by 21 ms. The physical layer processing circuit 30 resynchronizes the ports 20 in the active state ST4.

The synchronization of the ports 20 means that the scramble/descramble training is conducted until the training code transmitted from the port 20 of the transmitting-end node becomes recognizable by the port 20 of the receiving-end node. Once the port 20 of the receiving-end node recognizes the training code transmitted from the port 20 of the transmitting-end node, the synchronization of the ports 20 is completed. The resynchronization means that the synchronization is carried out again after a sync-lost state occurs while the data is transferable.

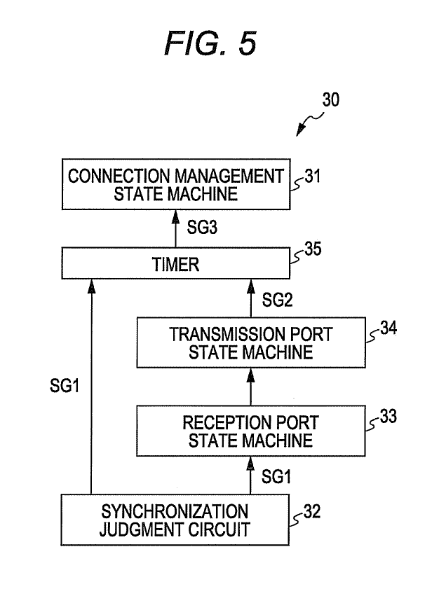

FIG. 5 illustrates an exemplary physical layer processing circuit. The physical layer processing circuit illustrated in FIG. 5 may be the physical layer processing circuit 30 illustrated in FIG. 3. The physical layer processing circuit 30 includes a connection management state machine 31, a synchronization judgment circuit 32, a reception port state machine 33 and a transmission port state machine 34 for synchronization and a timer 35.

The synchronization judgment circuit 32 judges whether the electrical signal such as the 10-bit data input from the other-party node B through the reception circuit 22 exists in the 10-bit/8-bit code conversion table or not. When the abnormal 10-bit data not existing in the code conversion table are received a given number of times continuously, the synchronization judgment circuit 32 judges that the synchronism is lost. The synchronization judgment circuit 32 outputs a detection signal SG1 indicating that the synchronism is lost to the reception port state machine 33 and the timer 35.

The reception port state machine 33 synchronizes the ports 20 and resynchronizes the ports 20 in accordance with the detection signal SG1. The reception port state machine 33 includes states STR1 to STR3, and changes the state of the ports to the desired state when a given transition condition is fulfilled. The reception port state machine 33 may be a state machine corresponding to the reception circuit 22 of the port 20.

The transmission port state machine 34 for synchronizing the ports 20, like the reception port state machine 33, resynchronizes the ports 20 in accordance with the detection of synchronism being lost. The transmission port state machine 34, upon completion of the synchronization or resynchronization of the ports 20, outputs a synchronization completion signal SG2 indicating the completion of synchronization to the timer 35. The transmission port state machine 34 includes states STT1 to STT3, and changes the state of the ports to the desired state when a given transition condition is fulfilled. The transmission port state machine 34 may be a state machine corresponding to the transmission circuit 21 of the port 20.

The timer 35 starts counting in accordance with the input of the detection signal SG1 from the synchronization judgment circuit 32. While starting the counting operation, the timer 35 outputs, to the connection management state machine 31, the state transition suppression signal SG3 for suppressing the transition from the active state ST4 to the suspended initiator state ST5 for a given time, for example, 21 ms. For this reason, the port state machines 33 and 34 resynchronize the ports 20 during the period when the connection management state machine 31 is in the active state ST4. The given time may be set as a time sufficient to complete the resynchronization while maintaining the active state ST4 from the detection of the synchronism being lost due to an instantaneous noise, such as static electricity.

When the synchronization completion signal SG2 is supplied from the transmission port state machine 34 within a given time, the timer 35 ends the counting operation and stops the output of the state transition suppression signal SG3. Since the resynchronization of the ports 20 is complete, the condition T6 for transition from the active state ST4 to the suspended initiator state ST5 is not met. Therefore, even if the state transition suppression signal SG3 ceases to be output, the connection management state machine 31 maintains the ports in the active state ST4.

Upon lapse of a given time without input of the synchronization completion signal SG2 from the transmission port state machine 34, the timer 35 stops counting and stops the output of the state transition suppression signal SG3. Since the synchronization of the ports 20 is not complete, the connection management state machine 31 makes the ports change from the active state ST4 to the suspended initiator state ST5 when the output of the state transition suppression signal SG3 stops.

The connection management state machine 31 is provided in correspondence with the ports 20 to manage the transition of the connection state of the ports 20. When the given transition condition is met, the connection management state machine 31 makes the ports 20 change to the desired state. Upon transition of the ports 20 to a given state by the connection management state machine 31, the connection state of the ports 20 corresponding to the connection management state machine 31 is changed similarly.

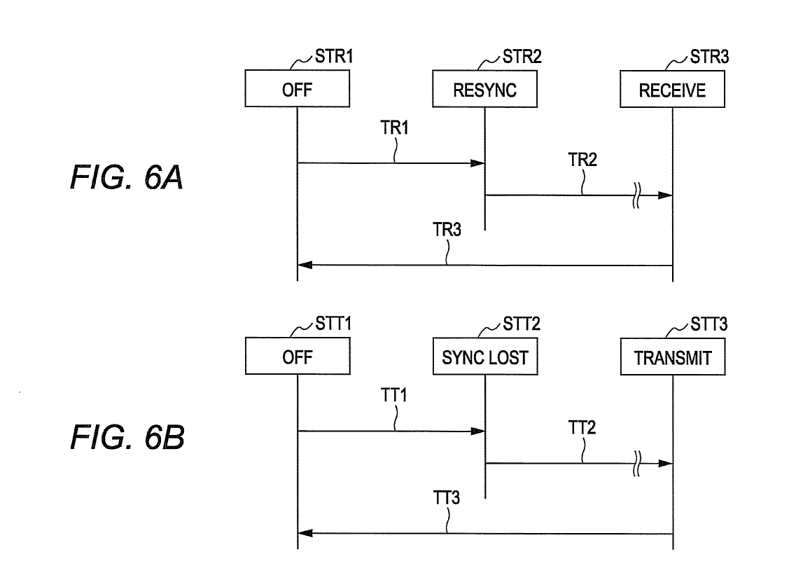

FIG. 6 illustrates an exemplary state transition of state machines. The state transition illustrated in FIG. 6 may be carried out by the state machines 31, 33 and 35 illustrated in FIG. 4. As illustrated in FIG. 4, the connection management state machine includes states ST1 to ST6. The disconnected state ST1 indicates the state in which a given port is not physically coupled to another port or the state in which a given port is physically coupled to another port and the speed negotiation is going on. The untested state ST2 indicates the state in which the synchronization is established between a given port and another port coupled to the given port, for example the port 20 of the node B, and a loop test is conducted to judge whether a loop is formed or not in the topology. The loop disabled state ST3 indicates the state in which a port is logically disconnected by detection of a synchronism being lost or a loop. The active state ST4 indicates the state in which a port transfers the data. The suspended initiator state ST5 is passed through at the time of transition from the active state ST4 to the suspended state ST6 and indicates the state in which the ports are deactivated. The suspended state ST6 indicates the state in which a port is in a suspended state, or for example, in a dormant state.

The connection management state machine in disconnected state ST1 makes the ports change to the untested state ST2 when the connection management state machine detects the tone signal from the other-party node and the speed negotiation is completed normally (transition condition T1).

The connection management state machine, upon detection of synchronism being lost or a loop by the loop test in the untested state ST2 (transition condition T2), makes the ports change to the loop disabled state ST3. The connection management state machine, when the ports are physically disconnected in the loop disabled state ST3 (transition condition T3), makes the ports change to the disconnected state ST1. The connection management state machine, upon detection of a bus reset state in the loop disabled state ST3 (transition condition T4), makes the ports change to the untested state ST2.

The connection management state machine in the untested state ST2, if the synchronization is completed and no loop is detected by the loop test (transition condition T5), makes the ports change to the active state ST4.

When a synchronism being lost due to a noise or a physical disconnection is detected in the active state ST4 or the suspension process is executed in accordance with the suspend command or the like (transition condition T6), the connection management state machine 31 makes the ports change to the suspended initiator state ST5. During a given period from the detection of a synchronism being lost, the connection management state machine 31 receives the state transition suppression signal SG3 from the timer 35, and therefore, the transition from the active state ST4 to the suspended initiator state ST5 is suppressed. Even when a synchronism being lost is detected, the activate state ST4 is maintained before the lapse of the given time. In this active state ST4, the ports 20 are resynchronized. When the resynchronization of the ports 20 is completed within a given time, the transition condition T6 is not established. Therefore, even when the connection management state machine 31 does not receive the state transition suppression signal SG3, the active state ST4 is maintained as it is. After complete resynchronization, the data is transferred.

When the resynchronization of the ports 20 is not completed after a given time has lapsed from the detection of a synchronism being lost and the state transition suppression signal SG3 is not input, for example, when a synchronism being lost is detected by a physical disconnection, the port state is changed from the active state ST4 to the suspended initiator state ST5.

When the connection management state machine 31 makes the ports 20 change to the suspended initiator state ST5 (transition condition T7), the ports automatically make transition to the suspended state ST6. When the connection management state machine 31 makes the ports change to the suspended state ST6 through the suspended initiator state ST5 based on the detection of a synchronism being lost (transition condition T8), the ports automatically change to the disconnected state ST1. The connection management state machine 31, upon reception of a resume packet or a remote command packet at the time of transition of the ports to the suspended state ST6 based on the suspension process (transition condition T9), restores the ports to the active state ST4.

When, as illustrated in FIG. 6B, a port 20 is physically coupled to another port in the off state STT1 in which the ports are not synchronized and the speed negotiation is completed (transition condition TT1), the transmission port state machine 34 makes the ports change to the sync-lost state STT2. In the sync-lost state STT2, the synchronization of the ports 20 is started. In the sync-lost state STT2, the transmission circuit 21 transmits the training code to the reception circuit 22 of the other-party node B.

When, as illustrated in FIG. 6A, the port 20 is physically coupled to another port in the off state STR1 in which the ports are not synchronized and the speed negotiation is completed (transition condition TR1), the reception port state machine 33 makes the ports change to the resync state STR2. In the resync state STR2, the synchronization of the ports 20 is started. In the resync state STR2, the 10-bit boundary of the training code received by the reception circuit 22 is detected and the synchronization judgment circuit 32 judges whether the 10-bit data exists or not in the 10-bit/8-bit code conversion table. This synchronization of the ports 20 may alternatively be carried out when the ports are in the untested state ST2.

Upon completion of synchronization of the ports 20 by transmission and reception of the training code (transition conditions TR2, TT2), the reception port state machine 33 makes the ports change to the receive state STR3 and the transmission port state machine 34 makes the ports change to the transmit state STT3. Upon transition of the ports to the receive state STR3 and the transmit state STT3, the ports 20 make transition to the active state ST4 after conducting the loop test (referring to FIG. 4), and the data is transferred after executing the bus reset. The synchronization completion signal SG2 indicating the completion of synchronization of the ports 20 is output to the timer 35 by the transmission port state machine 34.

When a synchronism being detected is detected and the detection signal SG1 is input in the receive state STR3 (transition condition TR3), the reception port state machine 33 makes the ports change to the off state STR1 (referring to FIG. 6A). Upon detection of a synchronism being detected and transition of the ports to the off state STR1 by the reception port state machine 33 (transition condition TT3), the transmission port state machine 34 makes the ports change from the transmit state STT3 to the off state STT1 (referring to FIG. 6B). For example, the connection management state machine 31 makes the ports change from the active state ST4 to the suspended initiator state ST5 (referring to FIG. 6). Upon occurrence of a synchronism being lost due to an instantaneous noise, the flow illustrated in FIG. 1, for example, may be started. For example, when the transition condition TR1 is met after completion of the speed negotiation of the operation S10 illustrated in FIG. 1, the reception port state machine 33 makes the ports change from the off state STR1 to the resync state STR2. Upon fulfillment of the transition condition TT1, for example, after completion of the speed negotiation of the operation S10, the transmission port state machine 34 makes the ports change from the off state STT1 to the sync-lost state (out of synchronism) STT2. As a result, it may take time from the detection of a synchronism being lost to the start of the resynchronization.

According to the previous embodiment, the ports 20 of the connection management state machine 31 make no transition from the active state ST4 to the suspended initiator state ST5 and therefore the active state ST4 of the port 20 is maintained for a given period from the detection of a synchronism being lost. As a result, in the port 20 of the reception port state machine 33, the speed negotiation is already complete after changing to the off state STR1. Since the transition condition TR1 is met in this way, the ports 20 make transition to the resync state STR2. In the transmission port state machine 34, the speed negotiation is already complete by the time of transition to the off state STT1. Since the transition condition TT1 is met in this way, the ports 20 make transition to the sync-lost state STT2. When the ports 20 make transition to the sync-lost state STT2, the training code is transmitted from the transmission circuit 21 to the reception circuit 22 of the other-party node B and the resynchronization of the ports 20 is started. The port 20 of the other-party node B, by receiving the training code, detects the occurrence of a synchronism being lost and transmits the training code to the port 20 of the node A.

Upon completion of the resynchronization of the ports 20 by the transmission and reception of the training code, the port of the reception port state machine 33 makes transition to the receive state STR3, and the port of the transmission port state machine 34 makes transition to the transmit state STT3. The transmission port state machine 34, as illustrated in FIG. 4, outputs the synchronization completion signal SG2 indicating the completion of the resynchronization of the ports 20 to the timer 35.

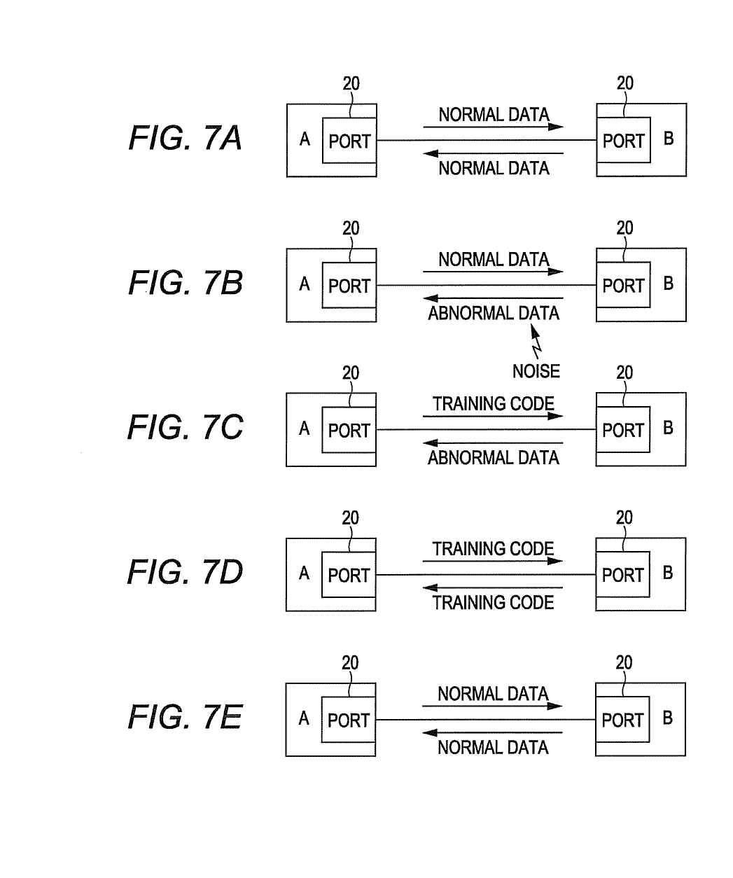

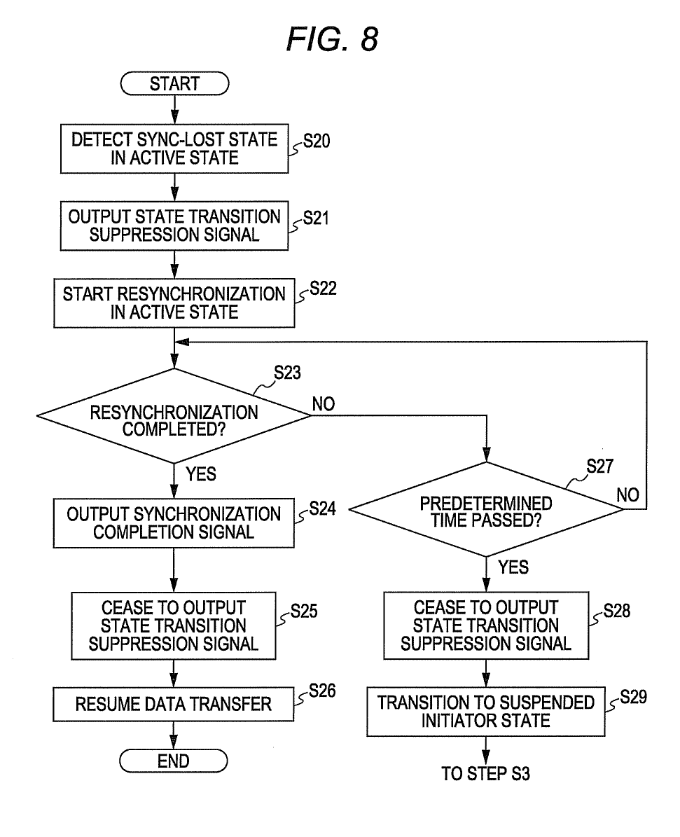

FIGS. 7A to E and 8 illustrate an exemplary resynchronization method. As illustrated in FIG. 7A, the data are transferred normally between the port 20 of the node A and the port 20 of the node B. The ports 20 of the nodes A and B may be in the active state ST4. When the data transmitted from the node B to the port 20 of the node A becomes abnormal due to a noise, such as static electricity, a synchronism being lost is detected by the synchronization judgment circuit 32 of the node A, and the detection signal SG1 is output to the timer 35 and the reception port state machine 33 (the operation 20 illustrated in FIG. 8). The timer 35 starts counting and outputs the state transition suppression signal SG3 to the connection management state machine 31 (operation S21). The port of the connection management state machine 31, without making transition from the active state ST4 to the suspended initiator state ST5, is maintained in the active state ST4. In the active state ST4, the resynchronization of the ports 20 is started (operation S22).

The reception port state machine 33, in accordance with the input of the detection signal SG1, makes the port change from the receive state STR3 to the resync state STR2 through the off state STR1. The transmission port state machine 34 makes the port change from the transmit state STT3 to the sync-lost state STT2 through the off state STT1. Based on the transition to the sync-lost state STT2, as illustrated in FIG. 7C, the training code from the port 20 of the node A is transmitted to the port 20 of the other-party node B.

Based on the reception of the training code, the synchronization judgment circuit 32 of the node B detects a synchronism being lost. The reception port state machine 33 of the node B makes the port change from the receive state STR3 to the resync state STR2 through the off state STR1. The transmission port state machine 34 of the node B makes the port change from the transmit state STT3 to the sync-lost state STT2 through the off state STT1. As illustrated in FIG. 7D, the training code is transmitted from the port 20 of the node B to the port 20 of the node A.

Upon completion of the resynchronization of the ports 20 of the nodes A and B based on the transmission and reception of the training code (YES in operation S23), the reception port state machine 33 makes the port change the receive state STR3, and the transmission port state machine 34 makes the port change to the transmit state STT3. The transmission port state machine 34 outputs the synchronization completion signal SG2 indicating the completion of the resynchronization to the timer 35 (operation S24). The timer 35, in accordance with the input of the synchronization completion signal SG2, ends the counting operation and ceases to output the state transition suppression signal SG3 (operation S25). Since the resynchronization of the ports 20 is complete, for example, no synchronism being lost has occurred, the transition condition T6 from the active state ST4 to the suspended initiator state ST5 is not established. As a result, the port 20 of the connection management state machine 31 is maintained in the active state ST4 where data is transferred. Therefore, upon completion of the resynchronization, as illustrated in FIG. 7E, the normal data transfer is resumed between the ports 20 of the nodes A and B (operation S26).

When a synchronism being lost occurs due to the physical disconnection of the bus cable between the nodes A and B, the resynchronization of the ports 20 is not completed even when a given time has lapsed from the count start of the timer 35, for example, the detection of a synchronism being lost (NO in the operation S23 and YES in the operation S27). The timer 35 ceases to output the state transition suppression signal SG3 (operation S28). Since the transition condition T6 is established in the connection management state machine 31 (ports 20), the port 20 makes transition from the active state ST4 to the suspended initiator state ST5 (operation S29). After that, the process of the operations S3 to S11 illustrated in FIG. 1 is executed.

Upon detection of a synchronism being lost, the transition of the ports from the active state ST4 to the suspended initiator state ST5 is suppressed, and the ports 20 are resynchronized in the active state ST4. Therefore, in the resynchronization, the operations S2 to S11 illustrated in FIG. 1 may not executed. Thus, the time before starting the resynchronization may be reduced.

For example, when a synchronism being lost occurs due to an instantaneous noise, the port of the connection management state machine 31 is maintained in the active state ST4 as long as the resynchronization is completed within a given time from the occurrence of the synchronism being lost. The data is transferred, therefore, without the loop test or the bus reset after complete resynchronization. Thus, the time from the completion of resynchronization to the data transfer may be reduced.

For example, when a synchronism being lost occurs due to an instantaneous noise such as static electricity, the suspension time of the data transfer may be shortened. For example, in the interface circuit 10 illustrated in FIG. 3, the data transfer is resumed within the short time of several ms after occurrence of a synchronism being lost due to an instantaneous noise. Even when a synchronism being lost occurs due to an instantaneous noise during the transfer of video or audio data, the video or audio data continues to be transferred without interruption.

According to the IDB1394 standard applicable to the on-vehicle equipment as a version of IEEE 1394b standard, for example, the resistance to the noise such as static electricity is required because the bus cable is not pulled in or off during the data transfer. The previous embodiment may meet this requirement.

When the resynchronization does not complete upon lapse of a given time from detection of a synchronism being lost, the output of the state transition suppression signal SG3 is stopped, and the ports make transition from the active state ST4 to the suspended initiator state ST5. Therefore, the resynchronization is limited in time. When a synchronism being lost occurs due to a physical disconnection or a node not including the interface circuit according to the embodiments is coupled, the ports are not maintained in the active state ST4.

When the state transition suppression signal SG3 is output, the ports make no transition from the active state ST4 to the suspended initiator state ST5 even when the bus cable between the ports 20 is physically disconnected. For example, when the resynchronization is not limited in time, the state transition suppression signal SG3 continues to be output as long as the resynchronization is not completed. For example, when the resynchronization is not completed with the physical disconnection, the state transition suppression signal SG3 continues to be output and the ports may continue to maintain the active state ST4.

For example, when the node B illustrated in FIG. 2 does not include the interface circuit according to the embodiments, the process in the flow illustrated in FIG. 1 is executed when a synchronism is lost. For example, when the resynchronization is not limited in time, the state transition suppression signal SG3 continues to be output until the resynchronization is completed. Therefore, the port 20 of the node A may continue to maintain the active state ST4. In the port of the node B, the synchronization is not started as long as the operations S2 to S11 illustrated in FIG. 1 are not completed. Since the port 20 of the node A is in the active state ST4, the port of the node B does not transfer from the operation S3 to the operation S4. As a result, the synchronization does not start between the ports of the nodes A and B, and the port 20 of the node A may continue to maintain the active state ST4.

Since the resynchronization has its own time limit, the state transition suppression signal SG3 ceases to be output when the resynchronization does not complete upon lapse of the time limit. Then, the ports make transition from the active state ST4 to the suspended initiator state ST5.

The transition condition of the transmission port state machine 34 and the reception port state machine 33 including the synchronization state machine may include the transition condition of the existing state machines. For this reason, the transition conditions of the port state machines 33 and 34 may not be changed.

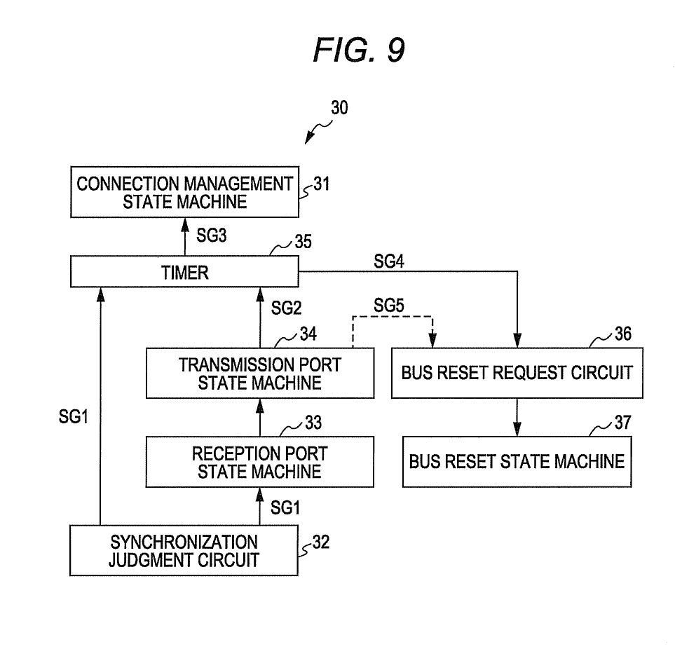

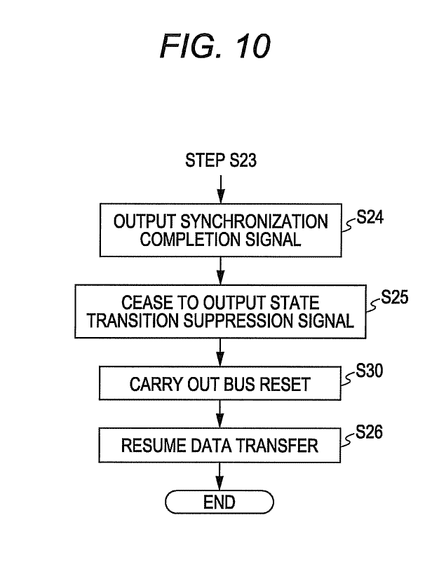

According to the embodiments, the data transfer is started after completion of resynchronization of the ports 20. The data transfer may be started, for example, after the bus reset or short bus reset following the completion of the resynchronization of the ports 20. FIG. 9 illustrates an exemplary physical layer processing circuit. The physical layer processing circuit illustrated in FIG. 9 may include a bus reset request circuit 36 for outputting a bus reset request to the bus reset state machine 37 in response to the resynchronization completion signal SG4 input from the timer 35. From the timer 35, the synchronization completion signal SG2 supplied from the transmission port state machine 34 after the detection signal SG1 is supplied from the synchronization judgment circuit 32 is output to the bus reset request circuit 36 as the resynchronization completion signal SG4. FIG. 10 illustrates an exemplary resynchronization method. As illustrated in FIG. 10, the bus reset is carried out between the operation S25 or S24 and the operation S26 (operation S30). Even when a bus reset occurs during the resynchronization of the ports 20 and the system configuration (topology) is changed, the normal data is transferred after resynchronization.

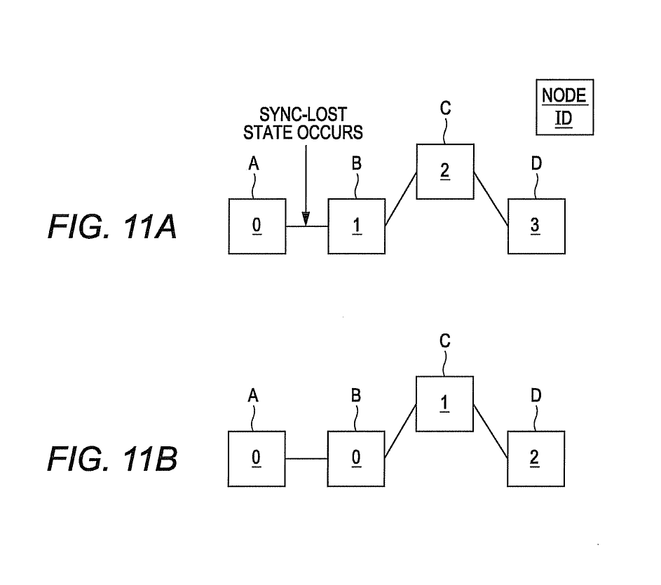

FIG. 11 illustrates an exemplary network system. When, in the topology illustrated in FIG. 11A, a synchronism is lost between the nodes A and B, for example, a bus reset may occur for the node D in the topology including the nodes B, C and D during the resynchronization between the ports 20 of the nodes A and B. Upon completion of the bus reset, the node IDs of the nodes B, C and D are newly determined. As illustrated in FIG. 11B, the same node ID as that of the node A may be attached to one of the nodes B, C and D, for example, the node B. Upon completion of the resynchronization between the ports of the nodes A and B after constructing this topology, two nodes ID of “0” exist in the topology including the nodes A, B, C and D, and therefore, the data may not be transferred normally.

As illustrated in FIG. 9, a bus reset occurs in the topology including the nodes A, B, C and D after completion of the resynchronization between the ports of the nodes A and B. Therefore, the node IDs of the nodes A, B, C and D are determined again. Since the duplication of the node ID is obviated, the data is transferred normally.

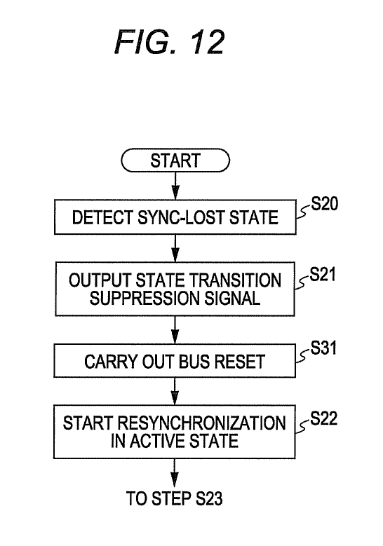

According to the embodiments, the ports 20 are resynchronized after a synchronism is lost. FIG. 12 illustrates an exemplary resynchronization method. As illustrated in FIG. 12, the ports 20 may be resynchronized (operation S22) after a bus reset or a short bus reset (operation S31) following the detection of a synchronism being lost (operation S20). For example, when a synchronism is lost between the nodes A and B in the topology illustrated in FIG. 11A, the ports of the nodes A and B may be resynchronized after the bus reset in each of the topology including the node A and the topology including the nodes B, C and D. Even during the resynchronization between the ports of the nodes A and B, therefore, the data are transferred between the nodes B, C and D. For example, the bus reset request circuit 36 illustrated in FIG. 9, may generate a bus reset request in response to the detection signal SG1 or the resynchronization start signal SG5 indicating the start of resynchronization that is designated by dashed line in FIG. 9 and is generated by the transmission port state machine 34.

The port of the reception port state machine 33 makes transition to the resync state STR2 through the off state STR1 when the reception port state machine 33 is in the receive state STR3 and receives the detection signal SG1 from the synchronization judgment circuit 32 (transition condition TR3). With this transition (transition condition TT3), the port of the transmission port state machine 34 makes transition from the transmit state STT3 through the off state STT1 to the sync-lost state STT2.

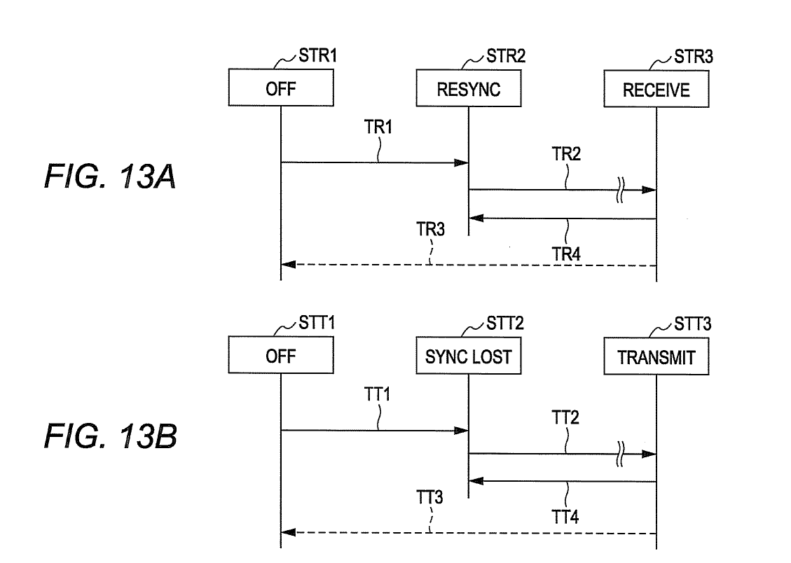

FIG. 13 illustrates an exemplary state transition of a synchronization state machine. As illustrated in FIGS. 13A and B, the transition condition TR4 may be added in place of the transition condition TR3 or the transition condition TT4 in place of the transition condition TT3. The port of the reception port state machine 33, as illustrated in FIG. 13A, makes transition from the receive state STR3 to the resync state STR2 when the reception port state machine 33 is in the receive state STR3 and receives the detection signals SG1 from the synchronization judgment circuit 32 (transition condition TR4). With this transition (transition condition TT4), the port of the transmission port state machine 34, as illustrated in FIG. 13A, makes transition from the transmit state STT3 to the sync-lost state STT2. Since this transition is not made through the off states STR1 and STT1, the resynchronization of the ports 20 is started earlier.

The port of the transmission port state machine 34, based on the detection signal SG1 from the synchronization judgment circuit 32, may make transition from the transmit state STT3 to the off state STT1 or the sync-lost state STT2.

The synchronization completion signal SG2 and the resynchronization start signal SG5 may be generated by the reception port state machine 33. According to the previous embodiments, the resynchronization is limited in time. For example, in on-vehicle applications where substantially no physical disconnection occurs during the data transfer and all the nodes of the topology includes an interface circuit 10, the resynchronization may not be limited in time. The timer 35 may include a state transition suppression circuit that outputs the state transition suppression signal SG3 to the connection management state machine 31 in accordance with the detection signal SG1 from the synchronization judgment circuit 32 and ceases to output the state transition suppression signal SG3 in accordance with the synchronization completion signal SG2. In this case, the operations S27 to S29 illustrated in FIG. 8 may be omitted.

Example embodiments of the present invention have now been described in accordance with the above advantages. It will be appreciated that these examples are merely illustrative of the invention. Many variations and modifications will be apparent to those skilled in the art.

1. An interface apparatus that transmits and receives data to and from a node coupled via a bus cable, comprising:
a port coupled to a port of the node through the bus cable;
a connection management state machine that corresponds to the port and changes the port from an active state to an inactive state when a synchronism of the port is lost;
a state transition suppression circuit that generates a state transition suppression signal to suppress the change of the port from the active state to the inactive state; and
a synchronization state machine that starts a resynchronization of the port in the active state based on the detection of the synchronism of the port being lost.

2. The interface apparatus according to claim 1,
wherein the state transition suppression circuit ceases to generate the state transition suppression signal after a given time has lapsed from the synchronism of the port being lost.

3. The interface apparatus according to claim 1,
wherein the state transition suppression circuit ceases to generate the state transition suppression signal upon completion of the resynchronization of the port.

4. The interface apparatus according to claim 3, further comprising:
a synchronization judgment circuit that generates a detection signal by judging whether the synchronism of the port is lost or not,
wherein the synchronization state machine generates a completion signal upon completion of the resynchronization of the port, and
wherein the state transition suppression circuit generates the state transition suppression signal based on the detection signal and ceases to generate the state transition suppression signal based on the completion signal.

5. The interface apparatus according to claim 4,
wherein the port includes:
a transmission circuit that transmits transmission data to the node; and
a reception circuit that receives reception data from the node,
wherein the synchronization state machine includes:
a transmission port state machine that corresponds to the transmission circuit, makes transition from a transmission state to a sync-lost state based on the detection of the synchronism of the port being lost, and starts the resynchronization of the port; and
a reception port state machine that corresponds to the reception circuit, makes transition from a reception state to a resynchronization state based on the detection of the synchronism of the port being lost, and starts the resynchronization of the port.

6. The interface apparatus according to claim 4,
wherein the port includes:
a transmission circuit that transmits transmission data to the node; and
a reception circuit that receives reception data from the node,
wherein the synchronization state machine includes:
a transmission port state machine that corresponds to the transmission circuit, makes a transmission state to a sync-lost state through an off state based on the detection of the synchronism of the port being lost, and starts the resynchronization of the port; and
a reception port state machine that corresponds to the reception circuit, makes transition from a reception state to a resynchronization state through an off state based on the detection of the synchronism of the port being lost, and starts the resynchronization of the port.

7. The interface apparatus according to claim 5,
wherein the transmission port state machine starts the resynchronization of the port by making transition to the sync-lost state and transmitting the synchronization data to the node.

8. The interface apparatus according to claim 6,
wherein the transmission port state machine starts the synchronization of the port by making transition to the sync-lost state and transmitting the synchronization data to the node.

9. The interface apparatus according to claim 1, further comprising:
a bus reset request circuit that generates a bus reset request upon completion of the resynchronization.

10. The interface apparatus according to claim 1, further comprising:
a bus reset request circuit that generates a bus reset request when starting the resynchronization.

11. A resynchronization method for a network system with a plurality of nodes coupled to IEEE 1394b ports,
when a synchronism of the IEEE 1394b ports is lost, suppressing a transition of the IEEE 1394b ports from an active state to an inactive state and starting a resynchronization of the IEEE 1394b ports in the active state.
